(19) United States
(12) Patent Application Publication
(10) Pub. No.: US 2010/0100277 A1
(43) Pub. Date: Apr. 22, 2010

(54) VEHICLE ODOMETER USING ON-BOARD DIAGNOSTIC INFORMATION

(75) Inventors: Brian J. Blythe, Fort Worth, TX (US); Eduardo M. Hinojosa, Fort Worth, TX (US)

Correspondence Address: Morani Patent Law, P.C., 10009 Georgian Woods Ct., Burke, VA, 22015, US

(73) Assignee: Williams-Pyro, Inc., Fort Worth, TX (US)

(21) Appl. No.: 12/577,165

(22) Filed: Oct. 10, 2009

Related U.S. Application Data
(62) Division of application No. 11/589,617, filed on Oct. 30, 2006, now abandoned.
(60) Provisional application No. 60/731,738, filed on Oct. 31, 2005.

(51) Int. Cl. G06F 19/00

(52) U.S. Cl. 701/33

(57) ABSTRACT

A vehicle has an engine and an on-board computer that controls the function of the engine. The on-board computer also provides diagnostic information, including instantaneous vehicle speed. The vehicle has an odometer that is present in the passenger compartment. The invention samples the instantaneous vehicle speed from the on-board computer and determines the distance traveled by the vehicle. The sampling rate can be adjusted depending on the speed of the vehicle. The odometer information can be sent off the vehicle by way of a transceiver.

### CROSS REFERENCE TO RELATED APPLICATIONS

The present application is a Divisional of U.S. patent application Ser. No. 11/589,617, which claims the benefit of U.S. provisional application Ser. No. 60/731,738, filed Oct. 31, 2005, the entire contents of both are incorporated by reference.

### FIELD OF THE INVENTION

The invention relates to apparatuses and methods for providing odometer information.

### BACKGROUND OF THE INVENTION

Odometers indicate distance traveled by vehicles. Odometers are typically mechanical or electrical. Mechanical odometers utilize a system of gears. A gear engages the output shaft to the vehicle transmission. As the vehicle moves, the gear is turned. The gear rotates a cable contained in a flexible sheath. The cable is connected to the odometer indicator, which is a series of dials turned by gears. Thus, for each predetermined number of cable revolutions, the lowest number dial on the odometer will turn to indicate distance traveled. The lower dial will turn the next place dial after a predetermined number of revolutions and so on.

Electrical odometers have a toothed wheel mounted to the transmission output shaft. A magnetic sensor produces a pulse for each tooth passing by. Alternatively, a slotted wheel with an optical sensor to detect the slots and produce a corresponding pulse may be used. The distance the vehicle travels between pulses is known. The electrical odometer counts the pulses to determine the overall distance traveled by the vehicle.

Vehicle odometers have indicators mounted on the dashboard inside the passenger compartment. The driver can easily see the odometer indication.

Obtaining automatic odometer readings, such as for use in an automated system, is difficult.

Vehicle odometer readings are useful in determining when repair or service to a vehicle is required. For example, oil changes, tire rotation and brakes are all serviced according to the odometer reading of the vehicle. As a further example, engine oil may need to be changed every few thousand miles.

Automated systems require the automatic acquisition of odometer readings. Automated systems allow maintenance tasks to be flagged and scheduled based on usage of a vehicle.

Prior art odometers are present on vehicle dashboards and are easily readable by a person sitting in the passenger compartment of a vehicle. However, obtaining odometer readings automatically, such as for use in an automated system, is difficult. One way is to use a visual system that reads the odometer indicator on the dashboard. For example, a mechanical odometer indicator could be read by a visual system. However, such a system is complicated and expensive. Electrical odometers could be tapped into. However, tampering with or altering an odometer circuit is illegal or discouraged. Because odometer readings affect the value of the vehicle, the integrity of those readings and the circuitry must be maintained. Still another way involves placing sensors in the transmission or on the driveshaft to obtain an odometer measurement independently of the vehicle odometer. However, this involves substantial installation skill and expense and requires calibration. Furthermore, the sensors require service.

### SUMMARY OF THE INVENTION

It is an object of the present invention to automatically provide odometer readings for a vehicle.

It is another object of the present invention to provide automatic odometer readings for a vehicle in such a way that does not affect the integrity of the existing on-board odometer.

The present invention provides a vehicle that comprises an engine and a transmission. There is a vehicle speed sensor and a first processor with an input connected to the vehicle speed sensor. The first processor has an output that provides the vehicle speed. A first odometer has an indicator in a passenger compartment of the vehicle. A second odometer comprises a second processor. The second processor has an input of the vehicle speed from the first processor. The second odometer comprises an integrator that operates on the vehicle speed and provides an output of distance traveled by the vehicle.

In accordance with one aspect of the present invention, the first processor comprises an electronic control module that controls the engine.

In accordance with another aspect of the present invention, the first processor output of vehicle speed is independent of the first odometer.

In accordance with another aspect of the present invention, the integrator comprises adjustable sampling intervals of the vehicle speed.

In accordance with still another aspect of the present invention, a transceiver is connected to the second processor output.

The present invention provides a vehicle odometer that comprises a vehicle speed sensor. A first processor comprises an input that is connected to the vehicle speed sensor and an output that provides instantaneous vehicle speed. The first processor has another output that controls the function of an engine. A second processor has an input that is connected to the first processor output. There is also a second processor output. The second processor samples the instantaneous vehicle speed and integrates the sampled vehicle speed to determine the distance traveled by the vehicle. The second processor provides the distance traveled at the second processor output.

In accordance with another aspect of the present invention, the second processor changes the frequency of sampling the instantaneous vehicle speed according to the vehicle speed.

In accordance with another aspect of the present invention, a transceiver is connected to the second processor output.

The present invention also provides a method of determining distance traveled by a vehicle. The operation of an engine in the vehicle is controlled as the vehicle travels. Diagnostic information on the operation of the engine is provided. The diagnostic information comprises vehicle speed. The vehicle speed is sampled and then it is integrated to determine the distance traveled by the vehicle.

In accordance with one aspect of the present invention, the step of sampling the vehicle speed further comprises sampling the vehicle speed at changing intervals of time that correspond to the vehicle speed.

In accordance with still another aspect of the present invention, the distance information is transmitted to a location off of the vehicle by a wireless communications link.

In accordance with still another aspect of the present invention, an odometer is provided in the passenger compartment of the vehicle. The odometer is independent of the steps of sampling and integration. Another aspect of the present invention is the secure transmissions between reader and tags.

### BRIEF DESCRIPTION OF THE DRAWINGS

FIG. 1 is a schematic diagram showing a vehicle and the apparatus of the present invention, in accordance with a preferred embodiment.

FIG. 2 is a block diagram of the apparatus of the present invention.

FIG. 3 illustrates trapezoidal integration using moderate time intervals.

FIG. 4 illustrates trapezoidal integration using smaller time intervals than in FIG. 3.

FIG. 5 illustrates varying the sample rate according to vehicle speed.

### DESCRIPTION OF THE PREFERRED EMBODIMENT

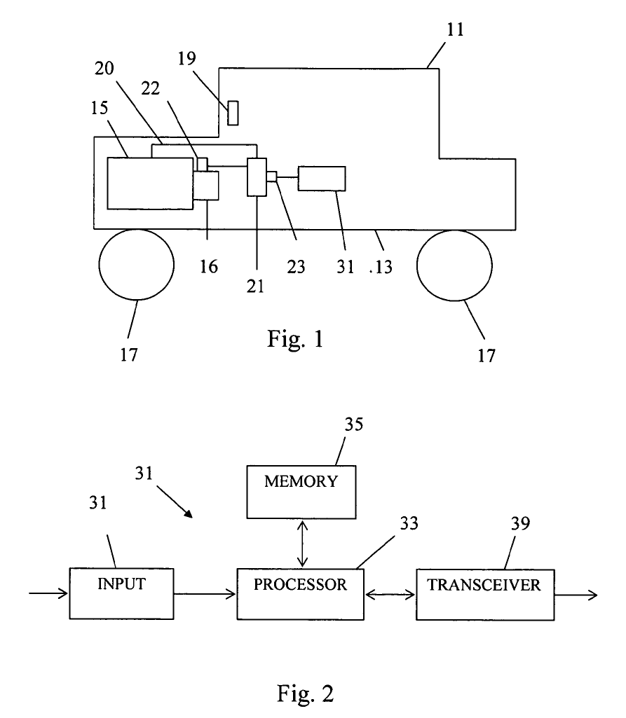

FIG. 1 shows a vehicle 11 having a body or chassis 13, an engine 15 and wheels 17. The engine can be an internal combustion engine, an electric motor, etc. The engine includes a transmission 16. The transmission 16 drives or powers the wheels 17 (either the front wheels or the rear wheels).

An odometer 19 provides information on the distance traveled by the vehicle. The odometer 19 can be of the mechanical type, which utilizes a gear at the transmission 16, a flexible cable, and an indicator with geared dials. The indicator is located in the passenger compartment. Alternatively, the odometer 19 can be of the electrical type, which uses a sensor located at the transmission 16 and an indicator in the passenger compartment. The odometer sensor could be a toothed wheel with a magnetic sensor, a slotted wheel with an optical sensor, etc. The indicator can be a visual display such as of the type that displays digits or numbers.

The vehicle also includes a diagnostic computer 21. The odometer 19 and diagnostic computer 21 are conventional and commercially available. Almost all vehicles come equipped with an odometer 19. In the last few years, most if not all vehicles are equipped with a diagnostic computer 21.

The diagnostic computer 21 is of the type found on vehicles. In the preferred embodiment, the computer is of the type OBD-II, which is an on-board diagnostic computer. The computer 21 is also an electronic control module (ECM). The computer 21 measures various parameters such as air intake, air intake temperature, engine speed, vehicle speed, air pressure, etc. These parameters are obtained by sensors. One such sensor is a vehicle speed sensor 22. The computer performs control functions for the engine and also provides diagnostic information on the engine and other vehicle components. The computer 21 provides one or more outputs 20 that control the engine 15 so as to maintain engine emissions within acceptable levels. Thus, the computer 21 controls the fuel and air entering the engine cylinders under a variety of operating conditions such as temperature, speed, load, etc. The computer 21 has an output, or diagnostic, port 23 that provides data to a reader or scanner console. The output port 23 is typically a connector located under the dashboard or under the hood. Currently, there are three basic protocols used for data transfer from the output port 23. One such protocol uses ISO 9141 circuitry. Another uses SAE 11850 VPW (Variable Pulse Width Modulation). Still another uses SAE 11850 PWM (Pulse Width Modulation). A mechanic who is working on an engine accesses the output port 23 and obtains information on the engine operation through fault codes. The present invention can be utilized with all types of protocols and on-board diagnostic computers or electronic control modules.

The vehicle speed sensor 22 provides speed signals to the computer 21. The computer 21 provides instantaneous vehicle speed at the output port 23. Instantaneous vehicle speed can be used to diagnose a problem with the operation of the engine. In addition, vehicle speed may be used to control other functions, such as torque converter lockup, and other control modules, such as the anti-lock brake system.

The vehicle speed sensor 22 measures transmission or transaxle output speed or wheel speed. The vehicle speed sensor 22 can be mounted in or adjacent to the transmission or transaxle and is connected directly to the computer 21. Alternatively, an intermediate module, such as a combination meter, can be connected between the vehicle speed sensor 22 and the computer 21. On a vehicle equipped with an anti-lock brake system (ABS), an ABS computer is intermediate the speed sensors 22 in the wheels and the computer 21.

The vehicle speed sensor 22 can be of various types. For example, the sensor can be of the pickup coil type, the magnetic resistance element type or the reed switch type. The pickup coil type utilizes variable reluctance and has a permanent magnet, a yoke and a coil. The sensor is mounted close to a toothed wheel. A voltage pulse is indicated in the coil each time a tooth passes by the sensor. The magnetic resistance element type uses a magnetic ring that rotates with the output shaft. The sensor senses the changing magnetic field and produces a sinusoidal wave that is converted into a digital wave. The reed switch type of sensor utilizes a speedometer cable. A magnet is mounted to the cable. As the cable rotates, the magnet opens and closes the contacts of an adjacent reed switch. In all of these sensor types, speed is determined by the frequency of pulses.

The present invention provides an apparatus 31 that utilizes the vehicle speed data from the computer 21 to provide odometer measurements and readings in a manner that can be automatically transferred from the vehicle. The apparatus 31 is located on the vehicle 11 and is connected to the output port 23 of the computer.

The apparatus 31, shown in FIG. 2, has a processor, or computer, 33, memory 35, an input device 37 and a transceiver 39. The memory 35 can be flash RAM (Random Access Memory) or some other storage device. The transceiver 39 provides communication between the vehicle 11 and a data collection site, which is located off of the vehicle. In the preferred embodiment, the transceiver 39 is wireless. Alternatively, data collection can be obtained from the apparatus 31 by other means, such as a cable connected to a reader or scanner console.

apparatus 31 monitors the instantaneous speed of the vehicle provided at the computer output port 23. Vehicle instantaneous speed is a generic parameter available from the on-board diagnostic computer 21. The present invention samples the instantaneous speed of the vehicle and integrates the sampled speed over time to determine the distance traveled by the vehicle. The distance, or odometer reading, is then provided externally of the vehicle by way of the transceiver 39.

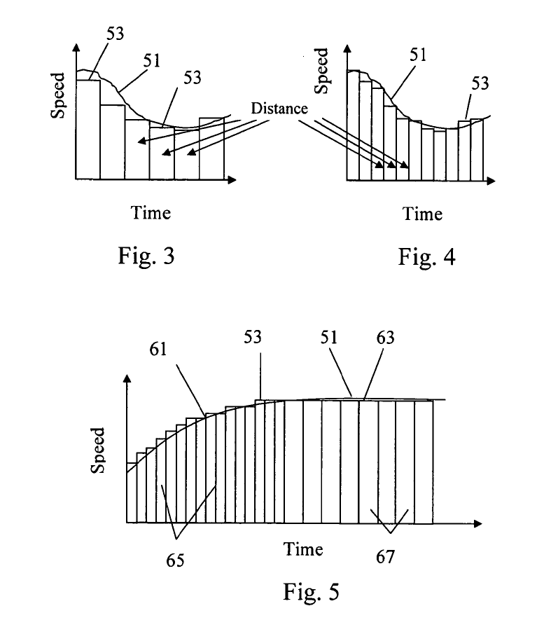

In the preferred embodiment, the distance traveled by the vehicle is determined using the trapezoidal method of integration, which breaks the speed as a function of time into a series of small rectangular portions. FIG. 3 FIG. 3 illustrates this. The distance traveled by the vehicle is determined for each sample time and these distances are then added together to determine total distance traveled. The preferred embodiment uses the equation below:

$$totalmiles \times 10 = \frac{\begin{matrix}( {\sum }_{n = 1}^{N - 1} A \times speedsamplen ) + \\ [ ( M - N \times A ) speedsampleN ]\end{matrix}}{conversionfactor}$$

where.

M=# of calculations,

N=# a f samples,

A=# of calculations per sample,

$$speedsample = measured speed in km \text{/} hr$$

$$conversionfactor = \frac{\begin{matrix}samplerate ( 1 \text{/} sec ) \times 3600 ( sec \text{/} hr ) \times \\ 1.609344 ( km \text{/} mi )\end{matrix}}{10}$$

For a sample rate of 2 times per second,

conversionfactor=2×3600×1.609344÷10≈1159,

FIG. 3 illustrates the technique using intervals of time sampling that are of relatively moderate interval lengths. The instantaneous speed 51 is sampled 53 periodically in time. The distance is the time interval multiplied by the speed over that interval. The distances are added together to obtain the odometer reading.

FIG. 4 illustrates the technique using shorter intervals of sampling time of the vehicle speed. This is more accurate in determining odometer measurements but requires more processing capability of the computer 33.

The invention can change either the sampling time of the vehicle speed or the determination of the odometer measurement for each sample speed, depending on the travel history of the vehicle. For example, if the vehicle is traveling on a highway, the speed is unlikely to change in a significant manner. Therefore, the computer 33 detects a relatively constant speed and can choose to make the odometer measurement less frequently.

Changing the sampling time of the vehicle speed is illustrated in FIG. 5. In FIG. 5, the vehicle undergoes two periods of speed. In an early period 61, the vehicle accelerates. In the next and later period 63, the vehicle travels at a relatively constant speed. In the early period 61 of acceleration, the sampling time 65 is relatively short. Thus, more samples per unit time are taken as the speed changes. In the later period 63 of relatively constant speed, the sampling time 67 is increased. Thus, fewer samples per unit time are taken as the speed stays relatively constant.

The sampling speed is set according to the change in vehicle speed. The computer 33 determines if the vehicle speed is changing by at least a predetermined amount. This is accomplished by comparing the vehicle speed samples for a number of samples. For example, if the speed over the last five samples changes by one kilometer per hour (kph), then the sampling speed is changed by a set amount. Varying the sampling speed allows computer 33 capability to be conserved.

The vehicle speed is provided as an input to the computer 33 by way of the input device 37. The computer 33 performs its processing and stores data, whether speed data or odometer data, in memory 35. The computer 33 periodically adds the distance measurements together to obtain total distance traveled. This adding can occur with each distance measurement, or after a predetermined number of time intervals or samplings has occurred, during relatively slow sampling rates 67 or periods (which is when the computer 33 has available processing capability), or after the vehicle has stopped moving for some period of time, or after the engine has been turned off.

When the vehicle travels once again, whether by restarting the engine or releasing the brake and so on, subsequent measurements are added to the odometer reading.

The odometer reading is transferred out of the apparatus 31 and off of the vehicle 11 by the wireless transceiver 39. A communications link between the transceiver 39 and a reader is established and the odometer information is then transferred to the reader. The apparatus 31 continues to accumulate odometer readings. Alternatively, the odometer measurements can be acquired through a wired connection, such as through a connector or other output device.

The present invention has several advantages. The apparatus 31 is easy and inexpensive to install, particularly in the aftermarket. Most, if not all vehicles come equipped with an on-board computer 21. The apparatus 31 is simply connected to the output port 23 of the on-board computer 21 and to an electrical power supply of the vehicle. There is no need to connect sensors to the transmission or the driveshaft, as required by prior art systems. Nor is there any need to tie into the existing odometer 19. Thus the integrity of the odometer 19 continues to be maintained. The odometer 31 of the present invention is independent of the dashboard odometer 19 in the sense that the odometer 31 does not tap into or splice into any odometer circuitry. The odometer 19 uses an existing output port 23.

Furthermore, calibration is not required as it is with prior art systems. While the odometer reading of the apparatus 31 will probably not be absolutely accurate, it is accurate when compared to the dashboard odometer 19. F or example, if the wrong size tires are installed on the vehicle, the speedometer will be inaccurate, thereby affecting the accuracy of the dashboard odometer 19, as well as the apparatus 31. Nevertheless, the apparatus 31 would continue to match the dashboard odometer 19.

The foregoing disclosure and showings made in the drawings are merely illustrative of the principles of this invention and are not to be interpreted in a limiting sense.

1-13. (canceled)

14. A vehicle odometer using an OBD processor output comprising:
a vehicle speed sensor configured to output speed data;
an OBD processor connected to an output of the vehicle speed sensor and receiving the speed data and configured to output an instantaneous vehicle speed via an OBD output port;
a connector configured to connect to the OBD output port and to an input of a non-OBD processor;
the non-OBD processor connected to the OBD output port via the connector and configured to determine a present sampling rate as a function of a variability of an at least two most recent instantaneous vehicle speed samples and configured to sample the instantaneous vehicle speed data at the present sampling rate; and
wherein, the non-OBD processor is configured to integrate the sampled instantaneous vehicle speed data with respect to the present sampling rate, obtaining sent distance and is configured to sum the present distance with a historical distance and to output a vehicle odometer reading.

15. The vehicle odometer according to claim 14, wherein:
the non-OBD processor is configured to increase a present sampling rate when five consecutive instantaneous vehicle speed samples vary by at least one kilometer per hour across the five consecutive vehicle speed samples.

16. The vehicle odometer according to claim 15, wherein:
after increasing the present sampling rate of, the instantaneous vehicle speed data, the non-OBD processor is configured to decrease a frequency of sampling the vehicle speed when consecutive vehicle speed samples do not vary by a specified amount.

17. (canceled)

18-23. (canceled)

24. The vehicle odometer of claim 14, wherein the OBD processor comprises an electronic control module configured to control an engine.

25. The vehicle odometer according to claim 14, further comprising:
an intermediate module connected to an output of the vehicle speed sensor and configured to output a speed data; and
wherein, the OBD processor is connected to an output of the intermediate module and is configured to receive the speed data from the intermediate module.

26. The vehicle odometer according to claim 25, wherein:
an anti-lock brake system computer is the intermediate module.

27. The vehicle odometer according to claim 25, wherein the OBD processor is not connected to the vehicle speed sensor.

28. The vehicle odometer according to claim 14, further comprising:
a non-OBD memory connected to the non-OBD processor; and
wherein, the non-OBD processor is configured to store obtained instantaneous vehicle speed data in the memory and to retrieve and integrate the stored instantaneous vehicle speed data with respect to a respective sampling rate at a desired interval, obtaining a respective distance and configured to sum the respective distance with a historical distance and to output a vehicle odometer reading.

29. The vehicle odometer according to claim 28, wherein:
the desired interval is when a vehicle, which is connected to the OBD processor, is idling or off

30. The vehicle odometer of claim 14, wherein:
the OBD processor output of instantaneous vehicle speed is independent of an odometer and the odometer's indicator in a passenger compartment.

31. The vehicle odometer of claim 14, wherein:
the non-OBD processor is configured to evaluate the present sampling rate relative to a past variability of instantaneous vehicle speed and adjust the present sampling rate when the past variability of instantaneous vehicle speed exceeds a threshold level.

32. The vehicle odometer of claim 14 further comprising:
a transceiver connected to an output of the non-OBD processor.

33. A vehicle odometer using an OBD processor output comprising:
a connector configured to connect to an OBD output port and to connect to an input of a non-OBD processor;
the non-OBD processor connected via the connector to the OBD output port by the connector, and configured to sample instantaneous vehicle speed data from the OBD output port, and configured to determine a present sampling rate as a function of a variability of an at least two most recent instantaneous vehicle speed samples and configured to sample the instantaneous vehicle speed data at the present sampling rate;
an output port connected to non-OBD processor; and
wherein, the non-OBD processor is configured to integrate the sampled instantaneous vehicle speed data with respect to the present sampling rate, obtaining a present distance and is configured to sum the present distance with a historical distance and to output a vehicle odometer reading via the output port connected to the non-OBD processor.

34. The vehicle odometer according to claim 33, wherein:
the non-OBD processor is configured to increase a present sampling rate_when five consecutive instantaneous vehicle speed samples vary by at least one kilometer per hour across the five consecutive vehicle speed samples.

35. The vehicle odometer according to claim 34, wherein:
after increasing the present sampling rate of, the instantaneous vehicle speed data, the non-OBD processor is configured to decrease a frequency of sampling the vehicle speed when consecutive vehicle speed samples do not vary by a specified amount.

36. The vehicle odometer according to claim 33, further comprising:
a non-OBD memory connected to the non-OBD processor; and
wherein, the non-OBD processor is configured to store obtained instantaneous vehicle speed data in the memory and to retrieve and integrate the stored instantaneous vehicle speed data with respect to a respective sampling rate at a desired interval, obtaining a respective distance and configured to sum the respective distance with a historical distance and to output a vehicle odometer reading.

37. The vehicle odometer according to claim 36, wherein:
the desired interval is when a vehicle, which is connected to the OBD processor, is idling or off

38. The vehicle odometer of claim 33, wherein:
the OBD processor output of instantaneous vehicle speed is independent of an odometer and the odometer's indicator in a passenger compartment.

39. The vehicle odometer of claim 33, wherein:
the non-OBD processor is configured to evaluate the present sampling rate relative to a past variability of instantaneous vehicle speed and adjust the present sampling rate when the past variability of instantaneous vehicle speed exceeds a threshold level.

40. The vehicle odometer of claim 33, further comprising:
a transceiver connected to an output of the non-OBD processor.

41. A method of providing a vehicle odometer, the method comprising:
using a connection from an input of a non-OBD processor to an output port of the OBD processor;
connecting an OBD output port to an input of a non-OBD processor;
determining a present sampling rate;
sampling instantaneous vehicle speed data at the present sampling rate from the OBD processor output port to the input of the non-OBD processor;
storing the sampled instantaneous vehicle speed data as present instantaneous vehicle speed data in memory;
integrating the sampled instantaneous vehicle speed data with respect to the present sampling rate to obtain a present distance;
storing the present distance;
determining a next sampling rate as a function of variability across at least two most recent instantaneous vehicle speed data and the stored present instantaneous vehicle speed data;
sampling instantaneous vehicle speed data at the next sampling rate from the OBD processor output port to the input of the non-OBD processor;
storing the sampled next instantaneous vehicle speed as next instantaneous vehicle speed data in memory;
integrating the sampled next instantaneous vehicle speed data with respect to the next sampling rate to obtain a next distance;
storing the next distance; and
incrementing a historical vehicle odometer by the present distance and the next distance to obtain a vehicle odometer.

42. The method of providing a vehicle odometer according to claim 41, further comprising:
determining a variability of a most recent five consecutive instantaneous vehicle speed data received from the output port of the OBD processor; and
increasing the present sampling rate if the variability exceeds a first predetermined amount.

43. The method of providing a vehicle odometer according to claim 42, wherein, the first predetermined amount is one kilometer per hour.

44. The method of providing a vehicle odometer according to claim 43, further comprising:
after increasing the present sampling rate, determining a variability of a most recent five consecutive instantaneous vehicle speed data received from the output port of the OBD processor; and
decreasing the present sampling rate if the variability does not exceed a second predetermined amount.

45. The method of providing a vehicle odometer according to claim 41, further comprising:
storing sampled instantaneous vehicle speed data received from the OBD processor output port by the non-OBD processor in a memory and recording respective present sampling rates;
batch processing stored instantaneous vehicle speed data with respective present sampling rates to obtain distance measurements;
summing the distance measurements; and
incrementing a historical vehicle odometer by the summed distance measurements to obtain a vehicle odometer.

46. The method of providing a vehicle odometer according to claim 41, further comprising:
incrementing a historical vehicle odometer by the stored present distance to obtain a current vehicle odometer; and
wherein, the current vehicle odometer is incremented by the next distance to obtain a vehicle odometer.

47. The method of providing a vehicle odometer according to claim 45, further comprising:
connecting a transceiver to an output of the non-OBD processor;
receiving the vehicle odometer from the output of the non-OBD processor; and
transmitting the vehicle odometer to a remote computer or storage device.
